(19) United States
(12) Patent Application Publication
(10) Pub. No.: US 2018/0235361 A1
(43) Pub. Date: Aug. 23, 2018

(54) COMBINED MONITOR STAND AND DESK ORGANIZER

(71) Applicant: Noki Works, Burlingame, CA (US)

(72) Inventor: David Ching, Burlingame, CA (US)

(21) Appl. No.: 15/750,244

(22) PCT Filed: Aug. 18, 2016
(86) PCT No.: PCT/US2016/047554

§ 371 Date: Feb. 5, 2018

Related U.S. Application Data
(60) Provisional application No. 62/206,589, filed on Aug. 18, 2015.

(51) Int. Cl. A47B 21/03; A47B 21/06; F16M 13/02

(52) U.S. Cl. CPC A47B 21/0314; A47B 21/06; F16M 13/02; F16M 2200/00; A47B 2021/0364; A47B 2021/064; A47B 2021/0321

(57) ABSTRACT

A desktop organizer and monitor stand that enables a user-ergonomic arrangement of wired electrical components in a radial/starburst configuration above a desk to reduce electro-magnetic interference (EMI) as well as to increase the ability to position a large number of such devices on and around the surface of a desk.

### CROSS REFERENCE TO RELATED APPLICATIONS

This application claims priority to Provisional Patent Application No. 62/206,589 filed Aug. 18, 2015.

### BACKGROUND OF THE INVENTION

### Field of the Invention

The invention relates generally to a housing or mounting assembly for the visual output device of a computer designed to be placed upon or integrated into a desk or other work surface, and more particularly to such an assembly configured to optimize use of ancillary electronic devices while concurrently managing the electric wires associated therewith.

### Description of Related Art

A person that performs office work for extended periods can, over time, experience heightened levels of fatigue and discomfort. This in turn can lead to a loss of productivity, physical injury, and an acute decrease in psychological well-being. Office workers, and those who manage office workers, desperately seek ways to improve the office work environment to increase productivity, comfort, motivation, and health. The worker's chair and the ambient working environment have attracted a great deal of attention toward improving desk worker comfort. However, the design of the work desk and the arrangement/accessibility of the various work-related tools that rest on top of the desk (e.g., computers, phones, tablets and other electronic equipment), also contribute significantly to the worker's posture, ergonomics and health. In addition to improving postures, ergonomics and health for office workers, opportunities to improve desk design include increasing the useable portions of desk space and accessible storage space, increasing desk organization/reducing clutter, managing wires and power/data sources, and facilitating the use of accessories such as tablets, smart phones and digital drawing boards to name but a few.

The prior art has made various attempts to address some of these factors in connection with desk and/or desk organizer products. Examples include the development of monitor arms, laptop risers, and tablet holders. Each of these examples seek to raise the visual output device (i.e., display screen) to an ergonomic height. Attempts at storage solutions include paper trays, stand-alone pedestals, and desk organizers to name but a few. These products offer various forms of desktop organization, each with some degree of success.

Electrical wire management is a related issue. The number of electronic devices typically used by a single worker at a desk has been steadily increasing. Despite this proliferation in the number of electronic devices that a desk worker requires within reach on or around the desktop, the average desk size (and allocated floor space) has been shrinking. A 5-foot-wide desk is now mainstream, and even smaller workspaces are starting to emerge especially in urban areas. The wires extending between these electronic devices and their respective power/data sources has become an ever more challenging concern from a containment/aesthetic point of view. Presently, the preferred forms of electrical wire management in desk applications include bundling wires with ties, hiding them with covers and routing them in chases.

However, electromagnetic interference (EMI) has emerged as a growing problem in desk settings due to the plurality of electrical components in use and in close proximity (i.e., within comfortable reach of the user). EMI is the disturbance of operation of an electronic device when it is in the vicinity of an electromagnetic field generated by an external source—usually another electronic device and/or its transmission line(s) carrying power or data. The disturbance often degrades the performance of the electronic device or can even stop the device from functioning altogether. In the case of a data path, the effects of the disturbance can range from an increase in error rate to a total (i.e., catastrophic) loss of the data. The modern working desk environment now routinely requires a user to have many electronic devices constantly functioning and all within easy reach of the user. Each such electronic device usually includes at least one power wire, and in some instances also a data wire. Each electronic device and wire emits an electromagnetic field, and has the ability to affect other nearby components and/or their wires.

As more electrical power cables and communication cables are added to the desktop environment to support more electronic devices—which devices are becoming ever more complex and sensitive—the problem of EMI between their cables also increases. That is, as the density of wires increases within the limited (and now shrinking) space at a desk, EMI is becoming a real-world concern in many office environments. Those of skill in the art will understand the power cables located in close proximity to Ethernet and USB communication cables are known to adversely affect the connection speeds. And of course, it has long been known that analog transmissions (still used prolifically in desktop scientific lab equipment and audio equipment) are greatly affected by EMI. Thus, the present trend toward bundling with ties and such as a form of wire management only intensifies the EMI situation.

Finding an acceptable solution to minimize EMI for the desk environment is further complicated with the general desire not to permanently modify an existing office desk, such as by drilling holes or the like. Likewise, people that control a budget for outfitting an office by-and-large generally resist the urge to replace existing electrical and communication infrastructure that is otherwise is good working order, and similarly disfavor replacing office furniture (like the desk) which is otherwise perfectly serviceable. Any solution to improve the EMI problem must also be mindful of the need to place electronic devices and other items on the desk in positions that naturally accommodate good posture for working (preferably in an ergonomic correct position), and that do not obstruct the most-used portions of desk space.

One approach to reducing the harmful effects of EMI has been to shorten the spacial distances between the wired electronic devices located on the desk and their common connected destination, such as a hub of communications or power (e.g., a USB hub or power strip). By reducing the length of the wires that extend from the electronic devices to the hub, EMI is reduced, and one may expect at the same time an inherently better utilization of space on and around the desktop. As a further added benefit, shorter distances between wired electronic components may also enable a reduction in the wire gauge and/or in the wire isolation properties, which then directly affects material cost and weight, and allows an even greater number of wires to be fit into a smaller space without increasing EMI effects to problematic levels.

Unfortunately, no known prior art desk organizer system adequately facilitates the shortest possible distance between a plurality of wired devices and their common hubs of communications and/or power. And further, no known prior art desk organizer system adequately accommodates a plurality of electronic devices, including the monitor and the seeming overabundance of ancillary equipment, all positioned ergonomically at desk locations where an average user would typically want the devices to be positioned, and that conveniently allows most or all of the electronic devices to be hidden from view when not needed so as to enhance the perception of increased organization/reduced clutter which directly affects the worker's psychological health.

One example of a prior art attempt to organize desk space may be found in U.S. Pat. No. 7,551,432 to Bockheim et al., issued Jun. 23, 2009. In one of the many disclosed embodiments (specifically FIGS. 24 and 25), Bockheim et al. discloses a combined storage cavity and monitor stand, wherein the storage portion has cavities located behind the monitor capable of holding electronic components and other objects hidden behind the monitor. Bockheim's cavities, however, are blocked by internal support barriers that prevent certain vital electrical components, such as a hub for example, to be centrally positioned behind the monitor. As a result, Bockheim et al. is incapable of adequately minimizing the harmful effects of EMI. The wire-pass through holes provided in the central barriers of the Bockheim design are not easily accessible by a user in front of the monitor, who would find it exceptionally difficult to feed multiple wires through the holes when attempting to connect the wire end into a hub. As a result, a user will be motivated to more conveniently wrap the wires of electrical devices located on one side of Bockheim's stand around to the other side of the organizer stand in order to reach a hub placed in one of the cavities. Accordingly, while Bockheim offers the appearance of desktop organization, in fact the overall design does not effectively utilize the storage space to achieve optimum device density and as a result fewer, not more, electronic wired devices can be stored behind the monitor due to the unwanted EMI effects.

U.S. Pat. No. 6,672,225 to Pomodoro, issued Jan. 6, 2004, discloses a desk system which includes an integrated monitor stand and organizer shelves. The organizer shelves are open (i.e., not enclosed) and appear to be capable of holding electronic components and other objects hidden at least partially behind the monitor. As a result of not being enclosed, however, electrical components could easily fall off the back-side of the shelves especially when being moved for inspection/attention by the user who's view of such items is substantially blocked by the monitor in-between. And in settings where the rear of the desk is observable, a tangled mess of wires and components would be visible.

In yet another prior art example, U.S. Pat. No. 4,657,214 to Foster, issued Apr. 14, 1987, discloses a combination lipped shelf and pull-out drawer used as a stand for a computer monitor. The lipped shelf is intended to support reading copy, such as for re-typing exercises. The drawer can be pulled open without removing the copy material from the lipped shelf. Disadvantageously, however, the angle of the copy material necessarily tips severely when the drawer is opened, potentially making the copy difficult to view until the drawer is closed and the copy material is returned to its optimal viewing angle.

In summary, no desk organization system has been found that provides an adequate solution to the major issues confronting office worker productivity, comfort, motivation, and health, and which also improves the growing problem of EMI in and around the desktop caused by the proliferation of sensitive electronic devices within reach of a desk worker in an ever-diminishing size desk. There is therefore needed an invention that addresses display ergonomics for monitors, laptops, tablets, smart phones, and papers, that provides adequate desk storage, expertly balances the accessibility of electronic devices with the ability to hide them out of view to manage clutter, and which optimizes the power and wire networks that connect most if not all electronic devices to a source of power and/or data.

### BRIEF SUMMARY OF THE INVENTION

According to a first aspect of the present invention, a housing assembly is provided for the visual output device of a computer designed to be placed upon or integrated into a desk or other work surface. The assembly comprises a tower section with discernable left and right sides. An imaginary sagittal plane establishes a centerline that generally bisects the tower section into left and right portions. The tower section is comprised, generally, of a front-facing panel and a rear-facing panel. The front-facing and rear-facing panels are each disposed generally perpendicularly to the sagittal plane. These panels are spaced apart from one another to form an enclosed interior region therebetween. A mounting bracket is connected to the tower section for attaching at least one monitor or other type of visual output device of a computer. At least one concealed shelf is disposed within the enclosed interior region of the tower. The concealed shelf is adapted to store a plurality of electrical components behind the front-facing panel, and hence behind a monitor when attached thereto via the mounting bracket. The concealed shelf established the floor of at least one cavity within the enclosed interior region of the tower section. The cavity is accessible from at least one side of the tower section, and extends through the imaginary sagittal plane thus providing storage for a plurality of wired electrical components in an optimal configuration so as to minimize electro-magnetic interference (EMI).

The cavity established by the concealed shelf within the enclosed interior region enables an arrangement of electronic components in which the shortest possible distance is achieved with respect to a common hub of communications and/or power. By locating such a hub directly behind a monitor, generally along the sagittal plane of the housing assembly, EMI effects can be minimized while concurrently achieving optimal ergonomic positioning of electronic components with respect to a user poised in a normal working posture.

According to a second aspect of the present invention, the housing assembly includes a base section adapted to rest on, or otherwise rise above, the horizontal surface of a desk or other work surface. A drawer is disposed within and supported by the base section for fore and aft movement relative to the base section along a reciprocating path. The drawer has a drawer face that is generally planar, but with a rearward slant that tilts away from the user. An auxiliary holder on the drawer face is adapted to support an auxiliary user interface (e.g., a tablet or smartphone) in an upright-reclining posture for fore and aft movement in concert with the drawer, thereby optimizing the ergonomic positioning of the auxiliary user interface below a visual output device.

The novel base section with drawer feature contributes to an increase in worker productivity, and a reduction in physical injury, in that often accessed auxiliary user interface objects/devices can be placed in a rearward reclining orientation and moved back and forth together with the drawer to either optimally position the auxiliary user interface or to access items stored in the drawer without unduly disrupting the viewing/access angle of the auxiliary user interface. In addition to fostering an increase in productivity, worker comfort, motivation and health also benefit.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 is an exemplary perspective view of a housing assembly according to one embodiment of the present invention, disposed for use on the surface of a desk, with a monitor attached and with numerous wired electronic devices disposed in and around the housing assembly while managing electrical wires in an EMI-reduced configuration;

FIG. 2 is a perspective view of the housing assembly shown in FIG. 1;

FIG. 3 is a rear perspective view of the housing assembly of FIG. 2;

FIG. 4 is a perspective view showing the housing assembly placed on top of a desk with a monitor attached to its tower section, and with a keyboard supported in the auxiliary holder of the drawer so as to either allow a unique pecking style of typing or to temporarily reposition the keyboard for clearance so that the drawer can be opened;

FIG. 5 is a view as in FIG. 4 but showing the drawer in an open condition with the keyboard supported in the auxiliary holder having maintained its rearward slant despite having been moved closer to the user;

FIG. 6 is a side view of the housing assembly placed on top of a desk with a monitor attached to its tower section and with an auxiliary user interface (in the form of a tablet or smartphone) in the auxiliary holder of the drawer, wherein the drawer is shown in a partially opened condition in phantom;

FIG. 7 is a rear perspective view of the housing assembly with monitor attached and with numerous wired electronic devices as in FIG. 1, but wherein the tower section is depicted in phantom to reveal the arrangement of electrical wires within the enclosed interior region which reduce the effects of EMI;

FIG. 8 depicts an alternative embodiment of the mounting bracket portion of the assembly, in which two monitors can be supported side-by-side;

FIG. 9A is rear elevation view of the housing assembly, showing the cavities within the enclosed interior region which are designed to allow arrangement of electronic components concealed therein and yet still spaced apart by the shortest possible distance with respect to a common hub of communications and/or power;

FIG. 9B is a view as in FIG. 9A, but showing how the electronic components can be moved to locations outside the cavities with minimal displacement, and without disrupting the advantageous wire management scheme;

FIG. 10A is rear elevation view of an alternative embodiment of the housing assembly, wherein the primary and secondary shelves are segmented and supported on sliding interfaces to enable movement into and out of the cavities within the enclosed interior region of the tower section;

FIG. 10B is a view as in FIG. 10A, showing how the sliding shelf sections along with the electronic components can be moved to locations outside the cavities with minimal displacement, and without disrupting the advantageous wire management scheme of this invention;

FIG. 11 is rear elevation view of yet another alternative embodiment of the housing assembly, wherein the primary and secondary shelves do not extend beyond the left and right sides of the tower section, and wherein a barrier closes or blocks access to the cavities from one side; and

FIG. 12 is a perspective view as in FIG. 2, but showing a further alternative embodiment in which a top shelf is added to the tower section.

### DETAILED DESCRIPTION OF THE INVENTION

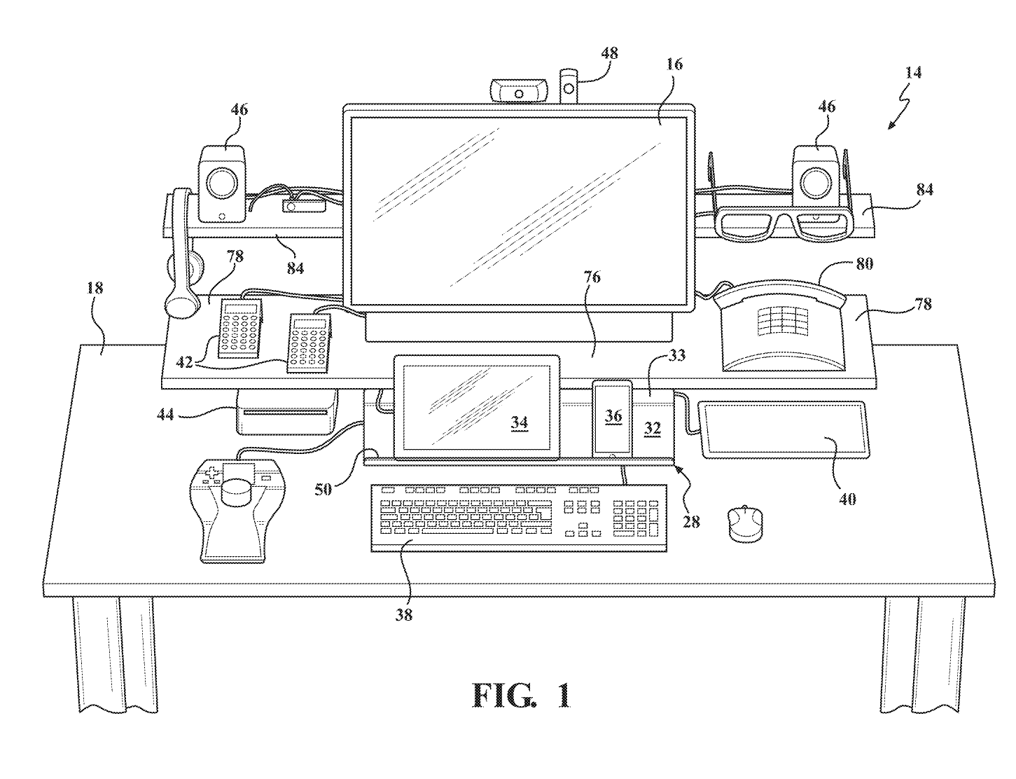

Referring to the figures, wherein like numerals indicate like or corresponding parts throughout the several views, a housing assembly is generally shown at 14. The housing assembly is designed to support a visual output device 16, such as a computer monitor or television screen or other type of viewing device. According to the preferred embodiments of this invention, the housing assembly 14 is designed to be placed upon a desk 18 or other work surface as depicted for example in FIG. 1. However, in some contemplated embodiments, the housing assembly 14 may be integrated directly into a desk system, such that the housing assembly 14 and desk 18 are fixed together as a unit.

The housing assembly 14 comprises a base section, generally indicated at 20, and a tower section, generally indicated at 22. One may imagine a vertical plane dividing the housing assembly 14 into left and right portions. In such a construct, this imaginary vertical plane coincides with the sagittal plane of a human user sitting directly in front of and facing the housing assembly 14 as in use. Hereinafter, this imaginary vertical plane of the housing assembly 14 will be referred to as its sagittal plane. The references “left” and “right” will be used throughout as would appear to a human user sitting directly in front of and facing the housing assembly 14. That is to say, the left- and right-hand sides of the housing assembly are designated as corresponding to the left- and right-hand sides of a user seated (or standing) in front of and facing the housing assembly 14 as depicted generally in FIG. 1. The sagittal plane thus establishes a centerline generally bisecting the assembly 14 into left and right portions.

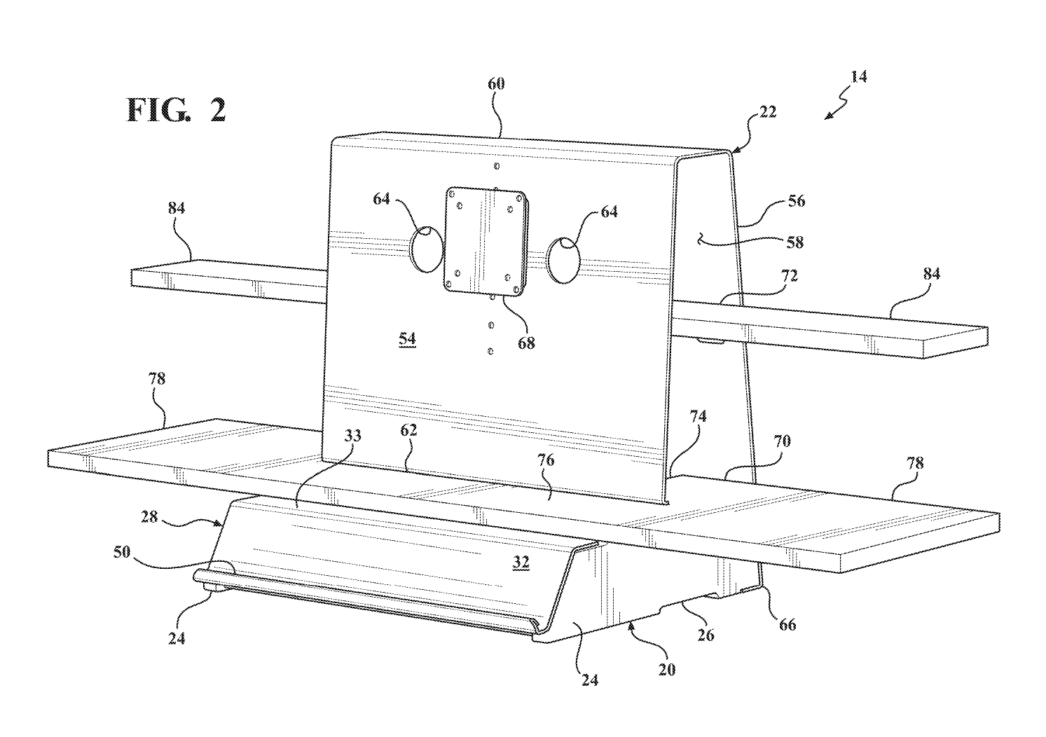

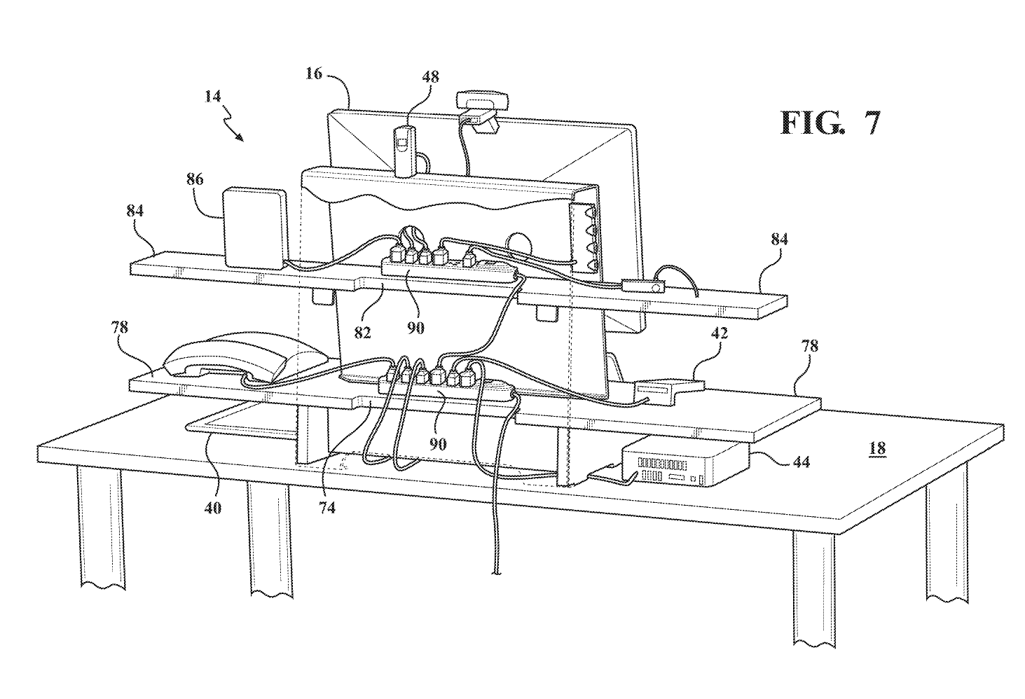

The base section 20 is shown among the Figures including left and right legs 24. The left and right legs 24 can take many different forms for the purpose of supporting the assembly 14 on the flat horizontal surface of a desk 18 or other support surface in those embodiments configured as a stand-alone organizer system. In cases where the housing assembly 14 is integrated into a desk unit (not shown), the legs 24 will naturally take different forms. For one example, the legs in a desk-integrated embodiment may simply comprise the sides for the lower portion of the assembly 14. Those of skill in the art will be able to envision other suitable adaptations. That is to say, the base section 20 may vary significantly from the illustrated examples when formed as an integrated part of a desk 18. It being understood that in the illustrated examples, the housing assembly 14 comprises a desk-top accessory of the type that simply rests upon an otherwise flat desktop. In these example, the legs 24 are oriented generally parallel to one another, and more or less equally laterally spaced apart on opposite sides of the aforementioned sagittal plane. In the illustrated embodiments, each leg 24 has a bottom edge adapted to rest on the horizontal surface of the desk 18. A small relief 26 may be formed in the bottom edges, as shown in FIG. 2, to form a defined gap. This gap may be used to pass electrical wires in a controlled and organized manner, as illustrated in FIG. 7.

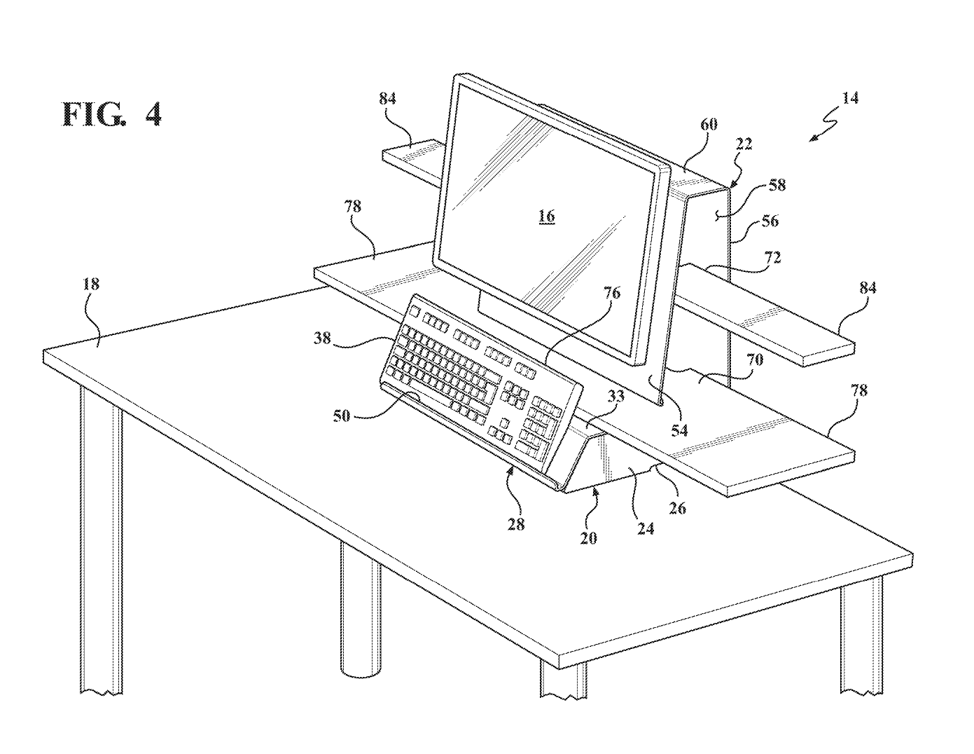

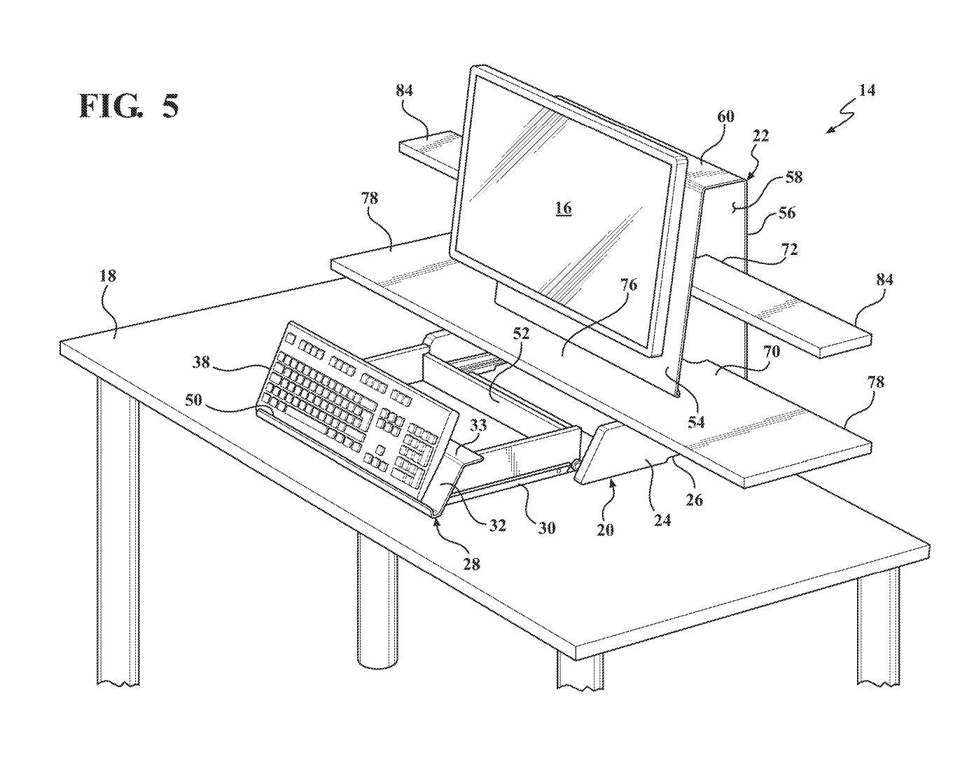

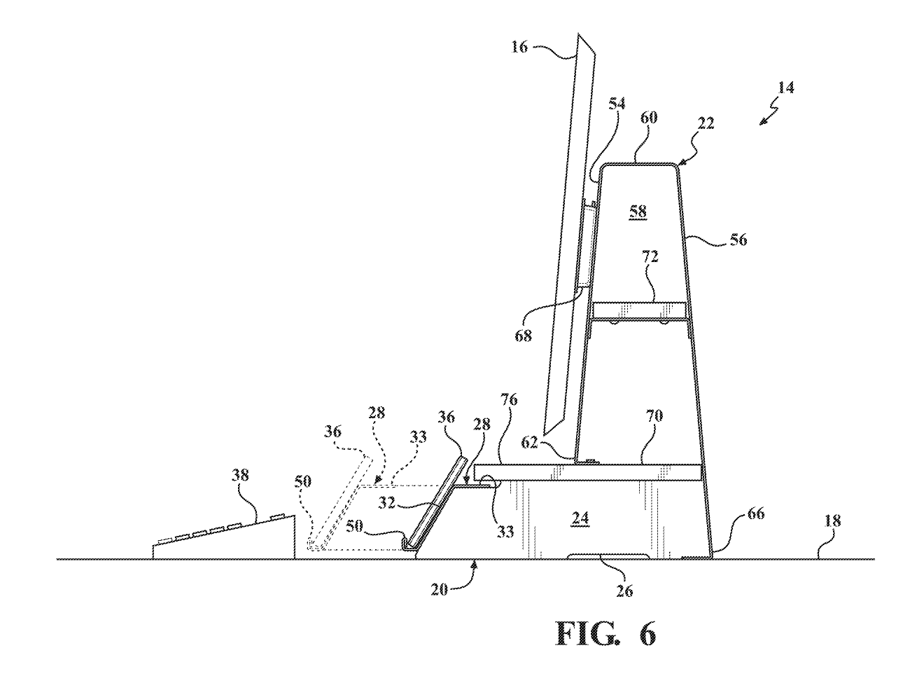

In the illustrated examples, a drawer 28 is supported in the base section 20. The drawer 28 is disposed between the left and right legs 24. As perhaps best shown in FIG. 5, draw slides 30 are shown operatively interconnecting the drawer 28 within the base section 20. The drawer slides 30 are shown in exemplary fashion as roller-style guides, it being understood that any configuration or mechanism that enables fore and aft movement of the drawer 28 relative to the left and right legs 24 along a reciprocating path generally parallel to the sagittal plane will suffice as a drawer slide 30. This may include solitary center-mount drawer slide mechanisms, simple sliding tongue-and-groove configurations, as well as the drawer sliding into and out of a hollow box-like cavity in the base section 20. In FIG. 4, the drawer 28 is shown closed, whereas in FIG. 5 the drawer is open. In FIG. 6, the drawer 28 is closed in solid lines, and opened (partially) in phantom.

Preferably, the drawer 28 is constructed as a box-like structure adapted to contain objects therein. However, in some contemplated embodiments, the drawer 28 may be relatively flat and without sides or a back like a pull-out breadboard. Regardless of its shape and configuration, the drawer 28 is provided with a functional drawer face 32 extending generally perpendicularly to the sagittal plane. In the illustrated examples, the drawer face 32 is generally planar and has a rearward slant tilting away from its bottom edge. That is to say, from the perspective of a user seated (or standing) in front of the housing assembly 14, the top edge of the drawer face 32 tilts or inclines away at a fixed angle. It is contemplated that the rearward slant angle could be adjustable by the user, however in the examples provided the rearward slant of the drawer face 32 is fixed at an angle between about 25°-75° relative to horizontal (i.e., to the surface of the underlying desk top). Slant angles greater than about 75° are considered too close to vertical, and slant angles less than about 25° are considered too flat to be practical. The top edge of the drawer face 32 may extend backward as a narrow flap 33. This flap 33 provides a degree of protection for the interior contents of the drawer 28, in cases where objects placed above the base section 20 (e.g., resting on front ledge 76) drop or spill.

The slant angle of the front face 32 has relevance because the drawer face 32 is configured to include an auxiliary holder of the type adapted to receive an auxiliary user interface in a reclining posture for fore and aft movement in concert with the drawer 28. The angle of incline of the drawer face 32, therefore, optimizes the ergonomic positioning of the auxiliary user interface below a monitor 16 (mounted to the tower section 22 or otherwise positioned above the base 20). The auxiliary user interface may be any object or device that a user may wish to interact with in a multi-tasking fashion while concurrently viewing information on the monitor 16. For example, the auxiliary user interface is depicted in the form of a tablet 34 in FIG. 1, a smartphone 36 in FIGS. 1 and 6, and a keyboard 38 in FIGS. 4 and 5. Other devices like those shown peripherally in FIGS. 1 and 7 may include a graphic/sketch tablet or tablet-style computer (e.g., a Microsoft® Surface®) 40. Other electrical devices, less likely to be placed on the auxiliary holder but nevertheless worth mentioning due to their depiction in FIGS. 1 and 6, include a calculator 42, a webcam 44, an external hard drive 46, a speaker 46, a wireless microphone 48, and the like. Indeed, the auxiliary user interface may not even be a wired electric or electronic item. For example, a notepad, book, reading glasses or writing utensils may also suffice as an auxiliary user interface.

The auxiliary holder can take many different forms, but in the illustrated examples is configured as a lip 50 formed continuously along the full width of the bottom edge of the drawer face 32. Alternatively, the lip 50 could be made either longer or shorter than the full width of the drawer face 32, or could be of segmented or crenulated design rather than continuous. As perhaps best shown in FIGS. 2 and 6, the lip 50 may have a generally hook-shaped configuration jutting outwardly from the drawer face 32. That is, the hook-shaped configuration has a generally J-shaped or L-shaped profile when viewed in cooperation with the drawer face 32. When an auxiliary user interface is placed on the lip 50, the rearwardly slanting drawer face 32 provides support for a reclining posture which is ergonomically convenient to a user seated in front of and facing the assembly 14, while the hook-shape retains the objects in place with reasonable security. Preferably, but not necessarily, the lip 50 is open at each of its left and right ends, as shown in FIGS. 2 and 4-5, so that an auxiliary user interface (e.g., keyboard 38) may extend beyond the edges of the drawer face 32 if desired.

Preferably, the lip 50 (and the bottom of the drawer 28) is elevated above the surface of the desk 18 by at least about ½″ so that the drawer 28 can glide over a flat keyboard (e.g., an Apple® keyboard), papers, pens and any other flat objects resting on the desktop. Thicker keyboards 38 can be temporarily placed on the lip 50 to instantly provide a clear path to quickly and conveniently open the drawer 28.

The drawer 28 may take many differ forms, and may be used to contain any desired object. Nevertheless, it is contemplated that in many instances the user will wish to store wired electronic items in the drawer, such as a smartphone 36. For example, there may be times when a user does not want to be distracted by message alerts appearing on the smartphone 36, and therefore temporarily hides the phone 36 in the closed drawer 28. Nevertheless, during such times the user may want the smartphone 36 (or other wired electronic device) to be plugged into a power (or data) supply. In the illustrated examples, the drawer 28 has a rear face 52 opposite the drawer face 32. The rear face 52 is configured to permit an electronic cable to be routed through. Such accommodation may comprise an aperture (not shown) in the rear face 52, or as depicted in FIG. 5 a lowered height so that cables can easily pass over top of the rear face 52. In this manner, when the drawer 28 is opened or closed, the electronic cables of any wired objects placed in the drawer 28 will comfortably pass through the rear of the drawer where they may be plugged into the source of out sight of the user, as shown for example in FIG. 7. Although not shown, the drawer 28 could include a suitable locking mechanism, as in a common key-operated desk drawer lock for example, for enabling a customary level of privacy and anti-theft deterrence with respect to contents contained within the drawer 28.

Another noteworthy feature of the slanted front face 32 of the drawer 28 is seen in combination with the preferred positioning of the monitor 16, which together yield a somewhat concave working interface as can be seen in FIG. 6. That is, an inwardly curving boundary is established by the slanted front face 32 of the drawer 28 and the monitor 16, which functionally and aesthetically invites a user to interact with the items supported on the assembly 14. Furthermore, a recommended placement of the assembly 14 on the desktop provides ideal ergonomics for the average user. In particular, the tower section 22 may be positioned, ideally, less than about 36 inches from the front (user-side) edge of the desk 18, and more preferably in the range of about 16 to 30 inches. In this location, the average user's hands can comfortably reach the various items placed on or attached to the assembly 14 while at work.

Despite the functional advantages of the drawer 28, it will be understood that the drawer 28 is in fact an optional feature which may be omitted is some contemplated embodiments. For example, one may imagine the base section 20 simply having the drawer 28 removed. In this case, the space once occupied by the drawer 28 becomes a cavity useful for storing objects below the monitor 16. Thus, while all of the illustrations show the drawer 28, certain configurations of the housing assembly 14 do not require the presence of a drawer 28 as may be defined by the claims.

The tower section 22 is coupled to the base section 20, such that the two members form a stable unitary structure. Like the base section 20, the tower section 22 may also take many different forms and configurations. FIGS. 2-6 illustrate one exemplary embodiment in which the tower section 22 comprises a front-facing panel 54 disposed directly over the (closed) drawer 28. The tower section 22 includes a rear-facing panel 56. These panels 54, 56 may be formed from sheet metal, plastic, wood or other suitable material. The illustrations generally depict the front- and rear-facing panels 54, 56 being integrally formed from a unitary piece of sheet metal, however these sections could be assembled together from multiple pieces using welding, gluing, mechanical fastening or other suitable techniques, or formed as a unity structure by some other manufacturing process such as extrusion or molding to name but two.

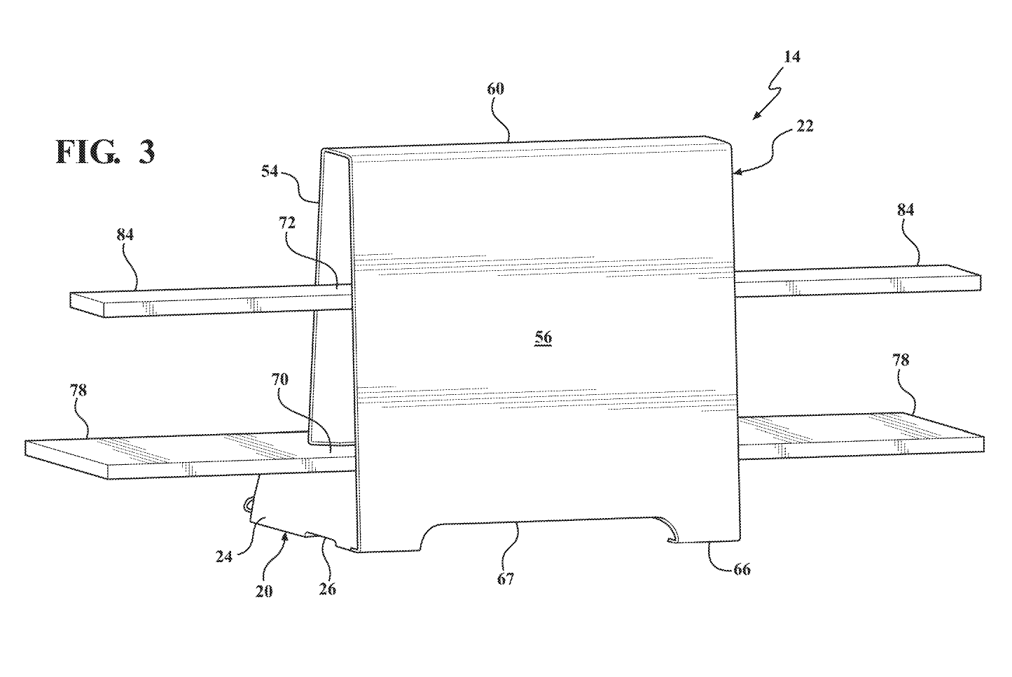

The front-facing 54 and rear-facing 56 panels are each disposed generally perpendicularly to the sagittal plane, and spaced apart from one another to form an enclosed interior region 58 in-between. The interior region 58, perhaps best seen in the side view of FIG. 6, comprises the enclosed or semi-enclosed space directly behind the front-facing panel 54. A bridge-like apex 60 connects the uppermost end of the front-facing panel 54 to the uppermost end of the rear-facing panel. The apex 60 delineates the uppermost boundary of the interior region 58 from the exterior, preferably in the form of a physical barrier. Although the apex 60 is shown, particularly in FIGS. 2 and 3, as being non-perforated, it is envisioned that one or more apertures could be formed in the apex 60 to allow pass-through cables, especially for objects placed on the shelf-like flat upper surface of the apex 60. In the examples shown in the drawings, the apex 60 is truncated so as to form a generally horizontal surface that is suitable for supporting objects as depicted in FIGS. 7 and 9A-10B. In other contemplated embodiments (not shown), the apex 60 can be peaked or rounded. In yet another contemplated example, the apex 60 can be skeletal in nature or perhaps even omitted entirely, such that in either case there is little or no physical barrier with respect to the interior region 58, and the uppermost edges of the respective front-facing 54 and rear-facing 56 panels delineate the uppermost boundaries of the interior region 58.

As best seen in FIG. 6, the front-facing panel 54 may be configured with a slight rearward tilt, in coordination with the typical slight rearward tilt of a computer monitor 16 when same is fixed at an ideal viewing height. Conversely, the rear-facing panel 56 may have a slight forward tilt so that the respective uppermost ends of the two panels 54, 56 converge toward the apex. This gives the tower a somewhat A-frame appearance, and contributes to the structural integrity of the assembly 14. Of course, in other embodiment, one or both of the front-facing 54 and rear-facing 56 panels could be vertical or even have an inverse slant if desired.

The front-facing panel 54 has a lowermost end 62 terminating on top of the base section 20. This lowermost end 62 may, as shown in FIG. 6, be formed as an inwardly directed flange through which a fastener or other suitable attachment technique may be applied to affix the tower section 22 to the base section 20. Other configurations for the lowermost end 62 are certainly possible. As shown in FIG. 2, one or more apertures 64 may be disposed in the front-facing panel 54 for routing an electronic cable(s) through. For example, the power and signal cables for a monitor 16 can be routed through the apertures 64 so that they pass into the interior region 58 for ultimate connection to power and signal sources.

The rear-facing panel 56 also has a lowermost end 66. However, unlike the lowermost end 62 of the front-facing panel 54, the lowermost end 66 of the rear-facing panel 56 extends behind the base section 20 and terminates substantially congruent with the respective bottom edges of the left and right legs 24. That is to say, in the illustrated embodiments, the lowermost end 66 of the rear-facing panel 56 is designed to rest directly on the surface of the desk 18. This provides strong structural support for the tower section 22, and also allows the lower section of the rear-facing panel 56 to enclose the drawer cavity in the base section 20. A relief 67 may be formed in the bottom edge of the rear-facing panel 56, as shown in FIG. 3, to form a gap through which electrical wires maybe routed in a controlled and organized manner, as illustrated in FIGS. 7 and 9A-11.

Those of skill in the art will readily envision alternative configurations, however, where the lowermost end 66 of the rear-facing panel 56 does not directly contact the desktop. For one example, both of the front-facing 54 and rear-facing 56 panels could terminate on top of the base section 20. In some possible variations, it may even be possible for both of the front-facing 54 and rear-facing 56 panels to terminate on top of the desk 18. Other contemplated variations include one or both of the front- and rear-facing panels 54, 56 being intentionally configured to provide EMI shielding to further reduce EMI transmission to objects on opposite sides of the shield, such as between devices located inside the tower section 22, the devices located on top of (or above) the apex 60, and the devices in front of the front-facing panel 54 like the monitor 16. Preferably, at least the tower section 22 is constructed of sheet metal which is known to provide a measurable degree of electromagnetic shielding. The base section 20 may also be made from sheet metal to achieve similar benefits.

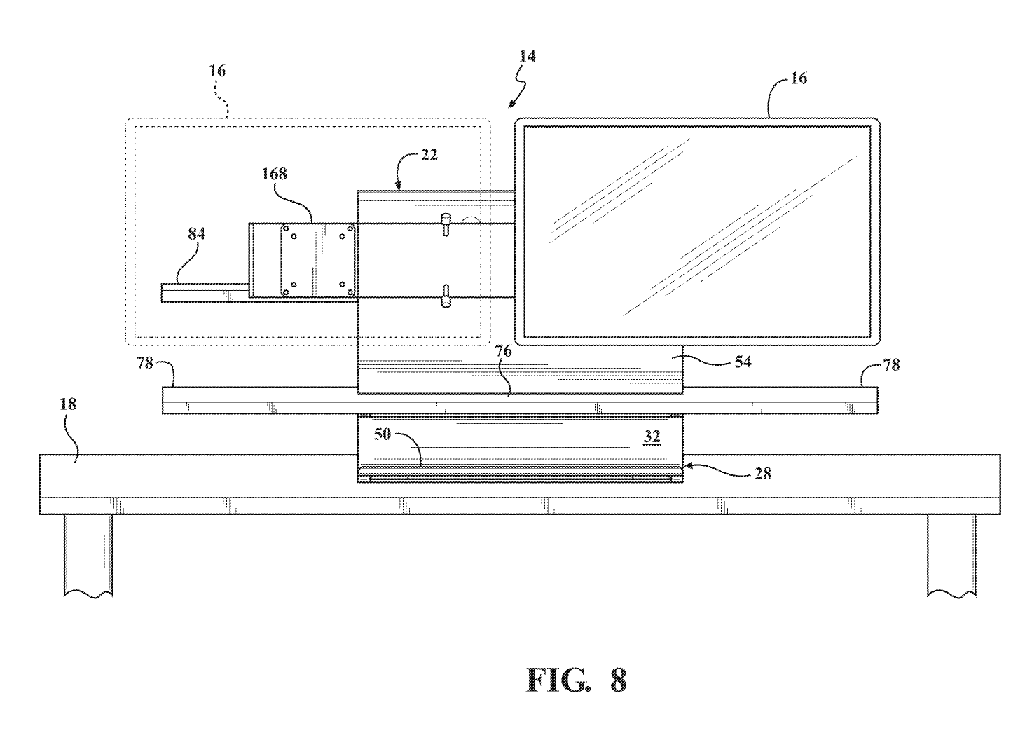

Returning again to FIG. 2, a mounting bracket 68 is shown connected to the tower section 22. Preferably, the mounting bracket 68 is directly attached to the front-facing panel 54. However, in other contemplated embodiments, the mounting bracket 68 may be indirectly connected, provided that is sufficiently secured in between the rear-facing panel 56 and the front edge of the desk 18. The mounting bracket 68 may be any commercially available design adapted to support at least one visual output device 16 of a computer, TV or another device. In some cases, the mounting bracket 68 may be designed to hold a laptop computer, where the screen of the laptop services as the monitor 16. Several pre-drilled mounting holes can be provided, as shown, to allow some user-specified variations in the vertical placement of the mounting bracket 68. Preferably, although not necessarily, the mounting bracket 68 is substantially centered along the sagittal plane of the housing assembly 14, and the apertures 64 in the front-facing panel 54 are disposed laterally adjacent the mounting bracket 68, on each flanking side as shown. The advantage to placing the one or more apertures 64 in close proximity to the mounting bracket 68 is so that power and signal cables extending typically from the rear of the monitor 16 are hidden from the view of the user as they are routed rearwardly into the interior region 58. An alternative mounting bracket 168 is shown in FIG. 8. In this example, the mounting bracket 168 is designed to hold two monitors 16 in side-by-side fashion. One such screen 16 is shown in phantom for clarity. Numerous other configuration options exist with respect to the mounting bracket 68, 168 to accommodate various types and arrangements of monitors 16.

The housing assembly 14 includes at least one concealed shelf in all of the illustrated embodiments. The concealed shelf comprises a generally horizontal support surface supported within the interior region 58. The one or more concealed shelves may be used to support a variety of electronic devices and other desk-related accessories such as those depicted for exemplary purposes in FIGS. 1 and 7. In one contemplated embodiment, the one or more concealed shelves are used to support long narrow boxes inside the interior region 58. The boxes can be pushed or pulled from either end (i.e., left and right side) to access contents placed therein. So for example, small boxes of paperclips, bottles of medicine, correction fluid, tissues and the like may be placed inside these narrow boxes and tucked neatly out of sight behind the monitor 16 when not needed. The boxes even be lidded to provide a degree of dust protection and security to items placed therein.

When the assembly 14 is configured with a plurality of concealed shelves, one such shelf is designated a primary shelf 70 and the others are designated accessory shelves 72. The primary shelf 70 is a generally horizontal support surface disposed at some ideal location within the tower section 22. In the preferred embodiments, the primary shelf 70 is supported above the base section 20. However, some alternative embodiments (such as those which omit the drawer 28 and/or base section 20 altogether), the primary shelf 70 may be affixed substantially on or slightly above the top of the desk 18. As perhaps best shown in FIGS. 2 and 4-5, the primary shelf 70 has a sheltered section that extends continuously and substantially uninterrupted through the enclosed interior region 58 of the tower section 22. That is to say, the sheltered section of the primary shelf 70 comprises the portion of the primary shelf that is located within the interior region 58, and which is preferably (but not necessarily) above the base section 20.

The sheltered section of the primary shelf 70 extends continuously and substantially uninterrupted through the tower section 22 so as to establish the floor of a cavity within the enclosed interior region 58 of the tower section 22. Said another way, the sheltered section of the primary shelf 70, which is an element of the more generally-stated concealed shelf, in conjunction with the enclosed interior region 58, forms the floor and walls of a cavity within the tower section 22. The floor of that cavity, which corresponds to the sheltered section of the primary shelf 70, provides a substantially unhindered surface to store and move (as by sliding back-and-forth thereon) electrical components and devices. As will be described in greater detail, the cavity within the enclosed interior region 58 enables an arrangement of electronic components in which the shortest possible distance is achieved with respect to a common hub of communications and/or power. By locating such a hub directly behind a monitor 16, generally along the sagittal plane of the housing assembly 14, EMI effects can be minimized while concurrently achieving optimal ergonomic positioning of electronic components with respect to a user poised in a normal working posture.

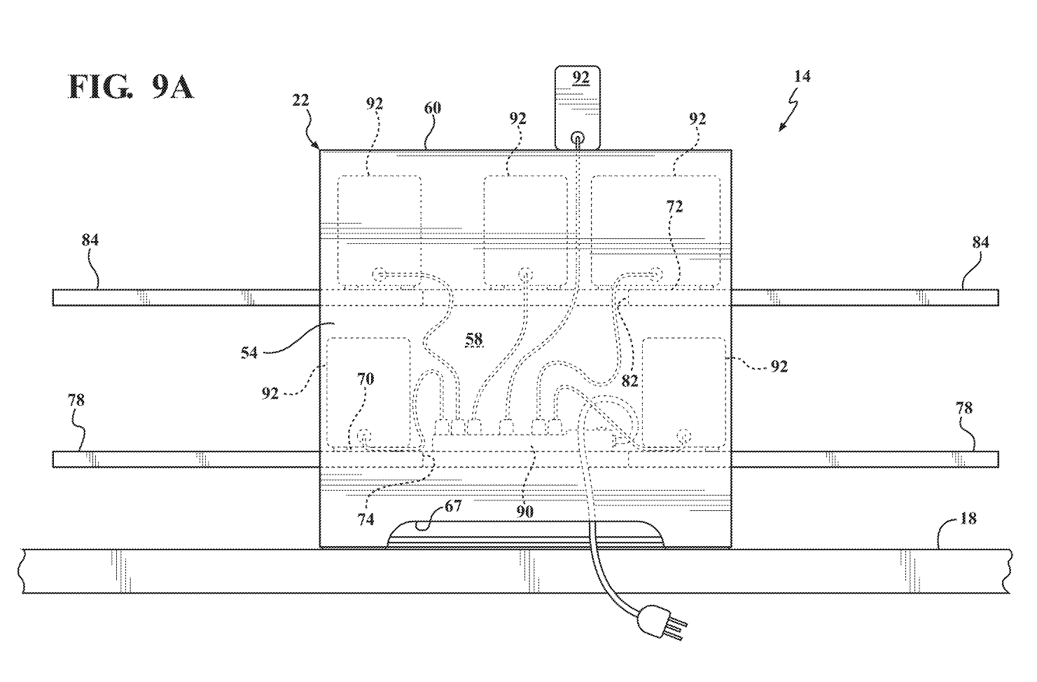

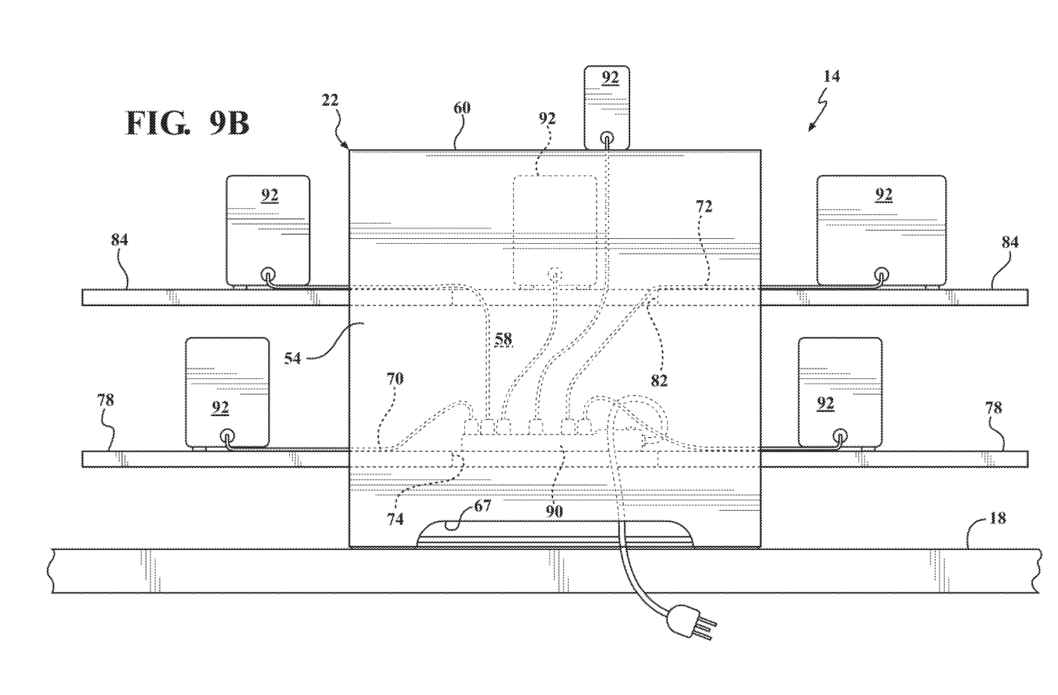

The cavity, which may be substantially barrier-free over its full transverse length, is accessible from at least one side (left/right) of the tower section 22, and more preferably accessible from both sides. Importantly, the cavity extends from at least one open side (left or right) of the tower section 22 through the sagittal plane, which enables new and especially advantageous benefits with relating to the reduction of electro-magnetic interference (EMI) and other advantages which will be addressed in detail below. The sheltered section of the primary shelf 70 is designed to provide an elongated wire slot 74 wholly contained within the interior region 58. The elongated wire slot 74, perhaps best shown in FIGS. 7 and 9A-9B, may be disposed directly adjacent the rear-facing panel 56 so that electrical wires emanating to/from objects located within and about the housing assembly 14 can be efficiently routed to accommodate the aforementioned EMI concerns as well as provide an aesthetically pleasing clean (i.e., generally free of loose wires) appearance.

In addition to the sheltered section, the primary shelf 70 may be further configured to include a front ledge portion 76 that is exposed (i.e., not within the interior region 58) and that extends outwardly from the front-facing panel 54. The front ledge portion 76 is located directly above the drawer 28 and directly below the monitor 16 to serve as an immediately accessible shelf for items a user may wish to have in easy reach and within eyesight when otherwise looking at the monitor 16. FIG. 1 perhaps best illustrates the convenient location of the front ledge portion 76 of the primary shelf 70.

Furthermore, the primary shelf 70 may include at least one primary wing 78. In the preferred embodiments, both left and right ends of the primary shelf 70 are fitted with primary wings 78 to give a balanced appearance and maximize usefulness. In this latter example, the primary wings 78 extend laterally outwardly from respective left and right sides of the sheltered section portion of the primary shelf 70 in cantilever fashion. In the example of FIGS. 1 and 7, these cantilever primary wings 78 can be used to support objects within convenient reach and eyesight such as a telephone 80 and a calculator 42. Moreover, a user may wish to normally locate certain objects out of sight in the interior region 58, yet temporarily move the objects into view when needed. The primary wings 78 enable such activity, by providing a continuous surface upon which to slide objects into and out of the interior region 58 without causing significant disruption to any power/data wire(s) that may be connected to the object. In this manner, the one or more primary wings 78 allow objects to be conveniently moved into and out of sight of the user, with very minimal spacial displacement, very minimal wire movement, and without placing the objects out of reach of a user seated (or standing) in front of the housing assembly 14.

As mentioned earlier, the housing assembly 14 may include a plurality of concealed shelves, with the second (and third, etc.) comprising an accessory shelf 72. The illustrated embodiments depict the inclusion of one accessory shelf 72, supported by the tower section 22. In particular, the accessory shelf 72 is disposed generally mid-way between the primary shelf 70 and the apex 60. In some respects, the accessory shelf 72 is similar to the primary shelf 70 in that both comprise a generally horizontal support surface disposed between the front-facing panel 54 and the rear-facing panel, and both include a sheltered section disposed within the enclosed interior region 58 of the tower section 22. And like the primary shelf 70, the sheltered section of the accessory shelf 72 extends continuously and substantially uninterrupted through the tower section 22 so as to establish a substantially barrier-free sliding surface within the enclosed interior region 58. The accessory shelf 72 includes at least one elongated wire slot 82. The elongated wire slot 82 is disposed directly adjacent the rear-facing panel 56, substantially directly above the elongated wire slot 74 of the primary shelf 70. Furthermore, the accessory shelf 72 includes at least one, but preferably two (i.e., left and right) accessory wings 84. The left and right accessory wings 84 extend laterally outwardly in cantilever fashion to support objects within convenient reach and eyesight such as speakers 46 (FIG. 1) or a wireless router or external hard drive 86 (FIG. 7) or any other object sufficiently suitable in size and weight. Such objects may be located in sight normally, but easily moveable out of view (i.e., into the interior region 58) when needed. The continuous surface provided by the accessory wings 84 enable objects to slide into and out of the interior region 58 without causing significant disruption to any adjoining power/data wire(s), and without placing the objects out of reach of a user when hidden.

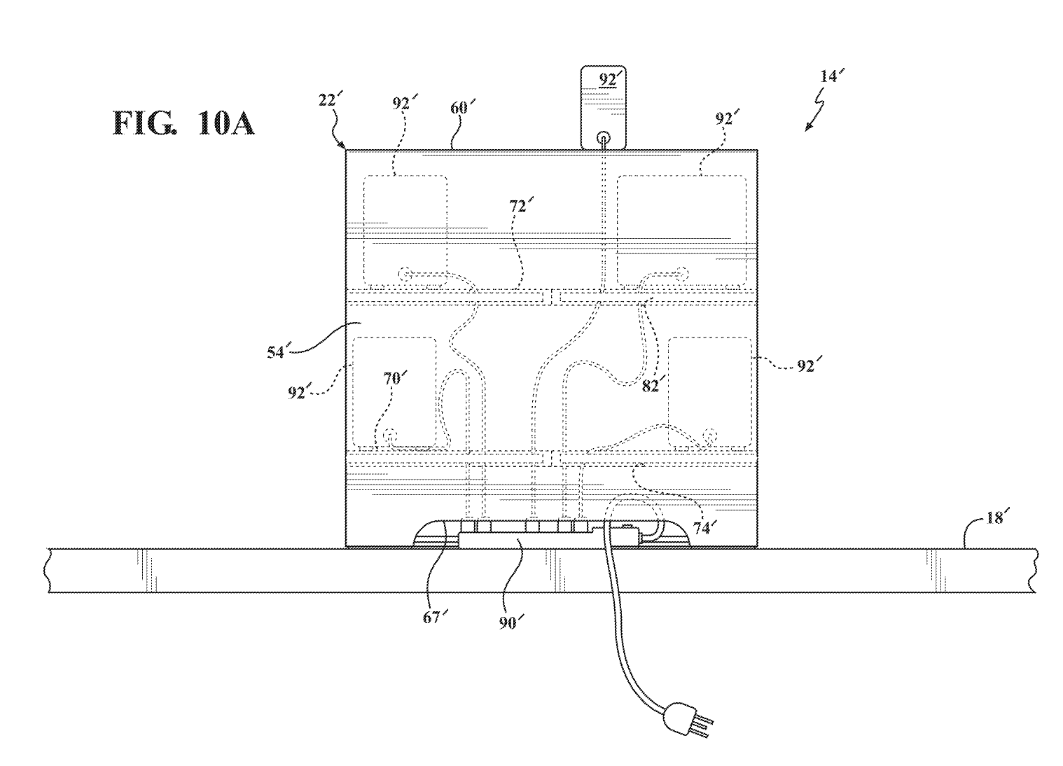

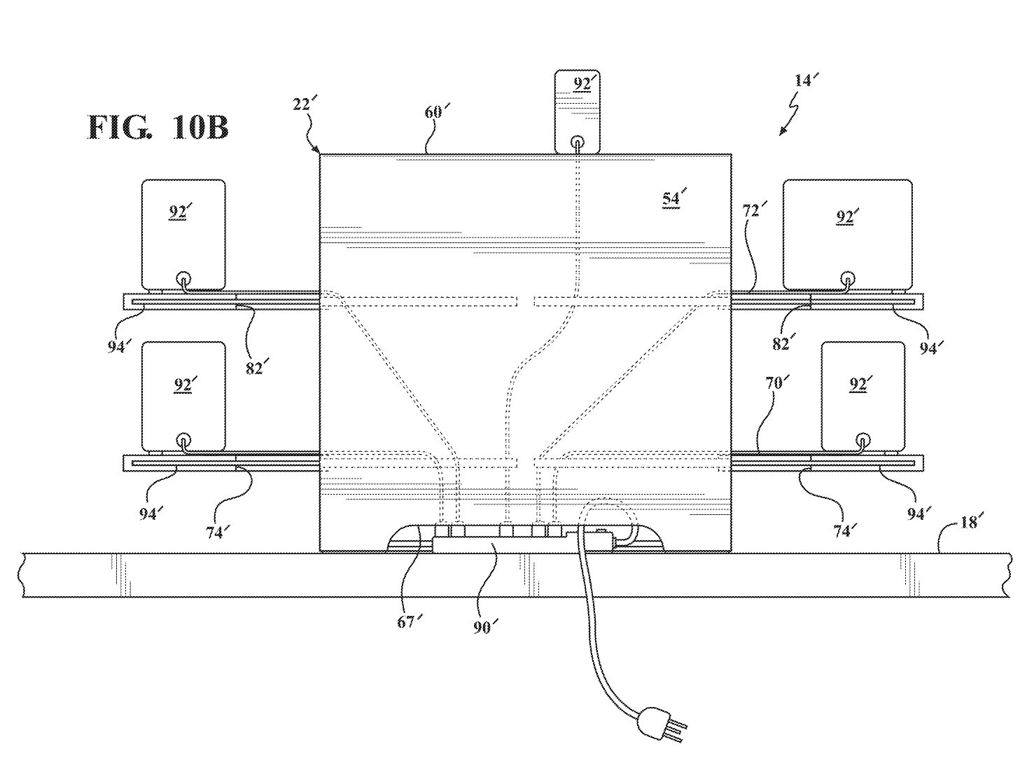

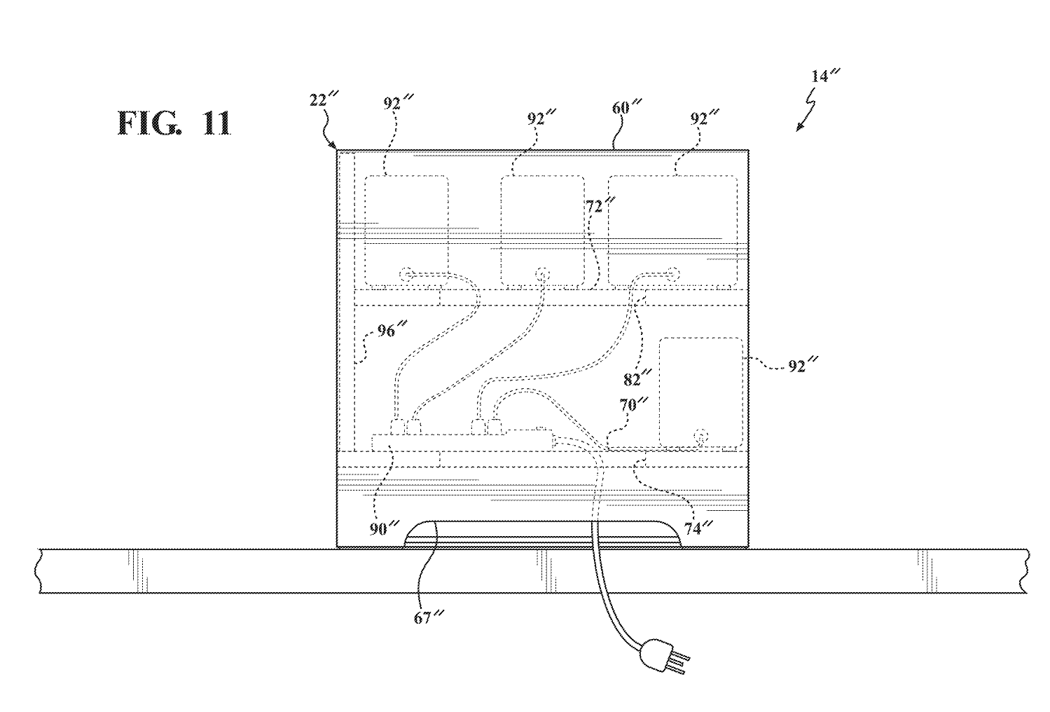

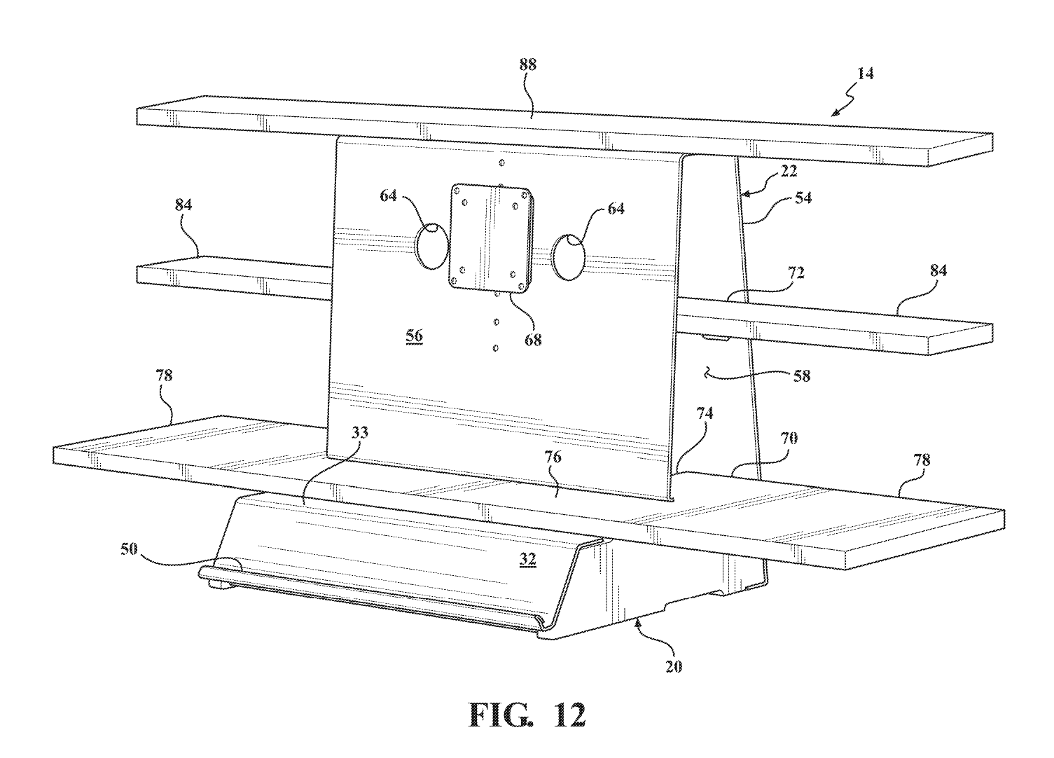

FIG. 12 depicts yet another variation wherein an optional top shelf 88 is provided. The top shelf 88 is attached to the flat apex 60 of the tower section 22, and has a length generally equal to the transverse lengths of the primary 70 and accessory 72 shelves. It is contemplated that a top shelf 88 will be especially advantageous in situations where two monitors 16 are used, like that shown in FIG. 8. In those situations, the wide spread of two monitors 16 make it slightly more difficult to access the accessory shelf 72, such that the higher top shelf 88 becomes a distinct benefit. Even more shelf variations will be described below in conjunction with FIGS. 10A-11.

The present invention represents a true desktop manager, in the sense that the housing assembly 14 enables the user to better organize and work within a relatively small working space, thereby improving productivity and emotional health. One particular advantage of the assembly 14 is attributed to its uniquely structured drawer 28 with its functional front face 32. The lip 50 on the drawer 28, in combination with the rearwardly angled front face 32, is configured as an auxiliary holder adapted to receive an auxiliary user interface in a reclining posture, and to enable fore and aft movement of the auxiliary user interface as the drawer 28 is pulled out/pushed in. The angle of the auxiliary user interface will not change as its position is adjusted back-and-forth, as shown in FIGS. 4-6. As a result, the user may easily adjust the distance (for reading and/or reach) of the items supported in the lip 50.

The auxiliary holder, which may advantageously take the form a hook-like lip 50 extending across the full width of the drawer face 32, receives any of a number of relatively thin objects in a reclining posture. The auxiliary holder places the object(s) in an ergonomically convenient location relative to the user seated in front of and facing the assembly 14. The relative distance between the user and the objects supported in the lip 50 can be adjusted by moving the drawer 28 in or out. In some embodiments, the drawer 28 is fitted with an extension lock or brake feature to secure the drawer 28 in a user-set position. This may be useful, for example, when the object placed in the lip 50 must receive pressure applied by the user, such as in the case of an active keyboard 38 (FIGS. 4 and 5), or in the case of a touch-sensitive electronic device such as the tablet 34 in FIG. 1 or the smartphone 36 in FIG. 6. A suitable extension lock for the drawer 28 can take many different forms. In one variation, the extension lock is designed to provide one or more pre-set positions. In another variation, the extension lock is designed more in the fashion of a friction brake that allows more-or-less infinite variability in setting the position of the drawer 28. The extension lock may be one-in-the-same with the aforementioned optional privacy lock, or installed as a distinct feature. In one possible variation, the extension lock is a distinct feature from the privacy lock, however the extension lock is configured to supplement the closed locking functionality of the privacy lock to provide additional security against theft.

Another distinct advantage of the drawer 28 is seen in its vertical spacing relative to the top of the desk 18. In the prior art, drawers opening at desktop level are generally disfavored due to items in front of the drawer blocking the opening path and/or the drawer face acting like a bull-dozer and pushing objects out of the way. Conversely, the drawer 28 of this present invention is intentionally elevated (e.g., about a ½″) above the surface of the desk 18 so that the bottom of the drawer 28 can glide over a flat keyboard (e.g., an Apple® keyboard), papers, pens and the like. This vertical spacing between the bottom of the drawer 28 and the top of the desk 18 also allows wires extending to items such as keyboards, pointing devices, and the like to remain undisturbed as the drawer 28 is opened and closed. Thicker objects, like the keyboard 38 shown in FIGS. 4-5, may be suitable to place on the lip 50 in order to clear the path quickly and conveniently so that the drawer 28 can be opened. In the example of FIGS. 4-5, the keyboard 38 remains functional in case the user decides to continue tapping keys while the keyboard 38 is held in its reclining position.

It will be appreciated by those of skill in the art that the advantages afforded by the uniquely designed drawer 28 are not dependent, necessarily, on any portion of the tower section 22. As such, another contemplated variant of the present invention is a desk organizer or desktop manager assembly in which a drawer 28 having the novel drawer face 32 of this invention is supported in a base section 20 alone. In this example, a monitor 16 could be placed directly onto the base section using its original equipment pedestal stand. That is to say, the present invention may be practiced in the form of a drawer 28 supported in a base section 20, with a monitor 16 resting on top of the base section 20. In this example, the drawer 28 remains fully functional to provide useful storage directly in front of the user while managing the typical prior art problem of clearing the space in front of the drawer when opening. And such a system also ergonomically supports one or more auxiliary user interfaces in a reclining posture with fore and aft adjustability.

Furthermore, the housing assembly 14 allows a relatively large number of electrical components to be in operation within close proximity to one another without aggravating electromagnetic interference (EMI). EMI is the disturbance of operation of an electronic device when it is in the vicinity of an electromagnetic field that is caused by another electronic or electrical device or its transmission cable. EMI is a problem in desk settings due to the plurality of electrical components in use and in close proximity The modern working desk environment now routinely requires a user to have many—perhaps a dozen or more—electronic devices constantly functioning and all within easy reach of the user. Each such electronic device usually includes at least one power wire, and in some instances also a data wire. Each device and its transmission wire emits an electromagnetic field, and has the ability to affect other nearby components and/or their wires.

A neat, orderly workspace is generally believed to contribute to increased worker morale and productivity. Aesthetically, tangled and disorganized wires from the numerous electrical components in and around the workspace of an office worker detract from a sense of neatness and orderliness. Therefore, to a promote a workspace that appears neat and orderly, the numerous electrical components are often grouped closely together. Their associated wires are often bundled together and hidden out of sight. However, this intentional close spacing of electrical components, and the bundling together of their wires for aesthetic purposes, is believed to exacerbate the EMI problem. Thus, the prior art solution to improving the aesthetic quality adversely affects the EMI situation, and the solution to the EMI issues adversely affects the aesthetics concerns.

In recent times, hubs have been developed to provide a common connection point for devices in a network. In general, a hub refers to a hardware device that enables multiple devices or connections to be connected to a computer. One specific example of a type of hub is a USB hub, which allows multiple USB devices to be connected to one computer. Another hub example is a power strip. Depending on the number of connections enabled by a hub, the physical size of a hub coupled with its cumbersome radiating wires can pose significant challenges to locating a hub in the desktop area.

Turning now to FIG. 7, a perspective view directed at the rear of the housing assembly 14 portrays the tower section 22 in fragmentary view with omitted edges in phantom, to reveal the natural arrangement of the various electrical devices and their wires enabled by its construction. Two hubs 90 in the exemplary form of surge protector/power strips are located within the interior region 58—one disposed on the sheltered portion of the primary shelf 70 and the other on the accessory shelf 72. To be clear, one or both hubs 90 could be other than of the power strip variety, such as a data hub, a USB connection hub, or other such hub-like device.

This present invention solves both the aesthetic quality and the EMI problems by providing a combination desk organizer and electronic display stand, i.e., the housing assembly 14, that cleverly minimizes wire distances and cross-mingling of wires via an interior region 58 which is strategically located in a central location behind the monitor 16, and which is hidden from view but otherwise readily accessible for the containment of various kinds of wired devices. The assembly 14 supports one or more electronic displays 16 in an ergonomic position just in front of the hub 90, along with numerous wired devices also in close proximity to the hub 90. In this manner, wire distances and cross-mingling of wires are minimized which has the direct effect of reducing EMI, while concurrently locating wired devices in ergonomic positions with respect to a user seated (or standing) in a normal working posture in front of the assembly 14. As a direct result, the assembly 14 enhances the opportunity for numerous electrical devices to work in close proximity to one another, and does so with little to no permanent modification to the existing desk environment.

The cavity within the enclosed interior region 58 of the tower section 22, which is accessible from at least one side of the tower section 22 and preferably from both sides, extends through the sagittal plane to reduce electro-magnetic interference (EMI) caused by a plurality of electrical components stored centrally behind the front-facing panel 54. In optimal cases, a hub 90 is located substantially in about the center of the interior region 58, behind the monitor 16 to reduce electro-magnetic interference (EMI). That is to say, the use of one or more hubs 90 is most effective when the hubs 90 are located within the interior region 58 and traverse the sagittal plane. This optimal central positioning of one or more hubs 90 is possible because the concealed shelf (i.e., the sheltered portions of the primary shelf 70 and/or the accessory shelf 72) spans across the sagittal plane and thereby enables access, storage and the arrangement for a plurality of wired electrical components 92 in a starburst (i.e., radiating) configuration. The partially concealed interior region 58 assists electronic devices and their associated wires to remain neatly contained, while still accessible and yet at the same time conveniently out of view behind the electronic display 16. The extension wings 78, 84 allow a user to move the electronic devices from their hidden location within the interior region 58 to a visible and more conveniently accessible location for attention—perhaps for checking or sending information, for adjusting connections, or disconnecting, etc.—and then back again to a concealed resting position within the interior region 58. When pushed back into the interior region 58, the components and their wires are much more likely to collide with other components and wires inside the interior region 58, which then might otherwise tend to cause a pile-up resulting in components spilling off the hidden back side of shelves 70, 72. Regardless of the purpose for which the electronic devices are moved out of the interior region 58, the extension wings 78, 84 prevent them from falling off the respective supporting shelf 70, 72 when moved out, and the enclosing nature of the tower section 22 (i.e., the front- and rear-facing panels 54, 56) prevents the electronic devices from being pushed out the back when returned to their original positions, which overall makes routine one-handed manipulation of the electronic devices possible.

FIGS. 9A and 9B illustrate the above-described functionality of the present invention which is configured to allow placement of electronic devices, collectively represented by reference number 92, and a hub 90, within close proximity of each other while dramatically reducing the effects of EMI. The assembly 14 is shown in rear elevation in these views. In FIGS. 9A-11, the black-box depictions identified by reference 92 could be any type of electronic device including but not limited to a tablet 32, a smartphone 36, an external hard drive 44, speakers 46, and the like. And likewise, the hub 90 could be any type of hub device, including but not limited to a power strip and a USB hub. The invention provides a cavity, in the form of the interior region 58, located directly behind the monitor 16, in which to place the hub(s) 90 and electronic devices 92 so as to reduce wire lengths. Furthermore, the cavity holding the hub(s) 90 and electronic devices 92 is strategically positioned on top of the desk 18 to further reduce the wire distances of connected electronic devices 92 located on and around the desktop. In addition, the partially concealed interior region 58 enables the devices 92 and their wires and the hub(s) 90 to be hidden from view for improved aesthetics. FIG. 9B shows how the novel extension wings 78, 84 provide external lateral support to enable the viewing and manipulating of items 92 moved outside the concealed cavity. By comparing FIGS. 9A and 9B, it will become clear that when a hub 90 is centrally located, the electronic devices 92 can be moved into and out of the interior region 58 without tangling the wires. The cables pass through the elongated wire slots 74, 82, and freely shift therein as the associated electronic devices 92 are slid back and forth. This, therefore, helps improve EMI by keeping the cables in as natural positions as possible, and to also maintain organization of the wires contained by the assembly 14. These slots 74, 82 represent improvements over the holes used typically in prior art designs, so that the wires slide horizontally as a user slides the hub 90 horizontally to change a connection while the associated devices 92 remain stationary. In comparison, the wire pass-through holes common in prior art designs require a user to pull and retract wires each time the hub is moved out and back for maintenance attention. Similarly, the slots 74, 82 allow the wires to slide horizontally when the associated devices 92 are moved yet the hub(s) 90 remain motionless, and thus are less likely to tension the cables which could result in abrasion and/or accidental unplugging.

Turning now to FIGS. 10A and 10B, another alternative embodiment of the housing assembly 14′ is shown in rear elevation. Prime designations (′) are added to reference numbers of the housing assembly 14′ in this embodiment. In these examples, the extension wings (previously 78, 84) are omitted in favor of dynamically supporting the sheltered sections of the primary 70′ and accessory 72′ shelves on slides 94′ or by some other articulating mechanism. The slides 94′ are intended to generically represent any type of method by which the sheltered sections of the primary 70′ and accessory 72′ shelves can be made to travel back-and-forth between positions within the interior region 58′ (FIG. 10A) and positions external (FIG. 10B) for viewing and/or manipulation. This can include sliding as well as pivoting and multi-jointed (e.g., four-bar) systems. The shelves 70′ and 72′ are seen to extend continuously and substantially uninterrupted through the tower section 22′ when in the collapsed condition shown in FIG. 10A.

The centrally located hub 90′ is, in this example, located on the surface of the desk 18′ yet still concealed within the tower section 22 of the housing assembly 14′. The electronic devices 92′ can be moved into and out of the interior region 58′ without tangling the wires, thus helping to reduce EMI disturbances and neatly managing the numerous wires.

In the embodiments of FIGS. 1-10B, the two cavities (one above the sheltered section of the primary shelf 70. 70′ and the other above the accessory shelf 72, 72′) are open to both left and right sides of the tower section 22, 22′. In this manner, the cavities are tunnel-like, allowing access from either side and facilitating cross-flow ventilation which can help to avoid temperature issues which can arise when many heat-producing electronic devices 92, 92′ are located in a confined space. The unimpeded pass-through nature of the cavities represents a distinct advantage of the present invention over certain prior art constructions. Nevertheless, a tunnel-like interior region 58 is not mandatory in all expressions of this invention.

FIGS. 10A and 10B also serve as a suitable context to mention that one or more of the concealed shelves could be configured with sides, back and/or a front like a drawer or box-like structure. A lid may even be included to provide a degree of dust protection and security to items placed in the box-like shelves.

FIG. 11 offers a still further alternative embodiment to emphasize the advantages of a substantially barrier-free cavity within the enclosed interior region 58″ of the tower section 22″, even if it does not possess an unimpeded pass-through tunnel-like configuration. Double prime designations (″) are added to reference numbers of the housing assembly 14″ in this embodiment. In this particular example, the extension wings (previously 78, 84) are omitted with no provision made to support the electronic components 92″ externally of the housing assembly 14″. And another distinction in this embodiment is that neither of the two cavities are open in tunnel-like fashion to the left and the right sides of the tower section 22″. Instead, an exemplary barrier 96″ is located along one side of the tower section 22″. Nevertheless, the sheltered sections of the primary 70″ and accessory 72″ shelves still extend through the sagittal plane so that a hub 90″ can be relatively centrally located and its cordage arranged in radiating pattern to reduce electro-magnetic interference (EMI) caused by the plurality of electrical components stored centrally behind the front-facing panel 54.

It may be helpful to mention the real practical dimensions associated with workspaces for humans and computer desks 18. The average size monitor 16 today is 24 inches, which is 22 inches wide horizontally. The average 6-outlet power strip (hub 90) is 11 inches in length but needs an additional 2 inches for the turn of its power wire at one end. The recommended viewing distance from a users' eyes to the monitor is about 18-24 inches. However, the average human arm length is about 25 inches. Therefore, providing hidden storage in the space eclipsed by the monitor 16 is practically limited. A storage space cannot be so wide or high before it is no longer hidden behind the average monitor 16. And a storage space cannot be so deep before the user cannot comfortably reach behind the monitor 16 to access items stored therein. For these reasons, the novel barrier-free cavity provided by the present invention, which crosses unimpeded through the sagittal plane, is particularly helpful in providing useful storage space in addition to reducing EMI effects and organizing a plurality of electrical components 92 stored centrally behind the front-facing panel 54.

The foregoing invention has been described in accordance with the relevant legal standards, thus the description is exemplary rather than limiting in nature. Variations and modifications to the disclosed embodiment may become apparent to those skilled in the art and fall within the scope of the invention. Furthermore, particular features of one embodiment can replace corresponding features in another embodiment or can supplement other embodiments unless otherwise indicated by the drawings or this specification.

What is claimed is:

1. A housing assembly for the visual output device of a computer designed to be placed upon or integrated into a desk or other work surface, said assembly comprising:
a tower section having left and right sides, a sagittal plane establishing a centerline generally bisecting said tower section into left and right portions, said tower section comprising a front-facing panel and a rear-facing panel, said front-facing and rear-facing panels each disposed generally perpendicularly to said sagittal plane and spaced apart from one another to form an enclosed interior region therebetween,
a mounting bracket connected to said tower section, said mounting bracket adapted to support at least one visual output device of a computer,
at least one concealed shelf disposed within said enclosed interior region of said tower and adapted to store a plurality of electrical components behind said front-facing panel, said concealed shelf forming the floor of a cavity within said enclosed interior region of said tower section, said cavity accessible from at least one side of said tower section and extending through said sagittal plane to enable storage for a plurality of wired electrical components in an optimal configuration in which electro-magnetic interference (EMI) is minimized.

2. The housing assembly of claim 1, wherein said concealed shelf includes at least one elongated wire slot disposed in said enclosed interior region.

3. The housing assembly of claim 1, wherein said at least one concealed shelf includes a primary shelf comprising a generally horizontal support surface, said primary shelf including a sheltered section thereof extending continuously and substantially uninterrupted through said enclosed interior region of said tower, said primary shelf including a front ledge portion extending outwardly from said front-facing panel.

4. The housing assembly of claim 1, wherein said at least one concealed shelf includes a primary shelf comprising a generally horizontal support surface, said primary shelf including a sheltered section thereof extending continuously and substantially uninterrupted through said enclosed interior region of said tower, said primary shelf including at least one primary wing, said primary wing extending laterally outwardly from said sheltered section.

5. The housing assembly of claim 1, wherein said at least one concealed shelf includes a primary shelf comprising a generally horizontal support surface, said primary shelf including a sheltered section thereof extending continuously and substantially uninterrupted through said enclosed interior region of said tower, said at least one concealed shelf further including at least one accessory shelf supported by said tower and disposed above said primary shelf, said accessory shelf comprising a generally horizontal support surface disposed between said front-facing panel and said rear-facing panel, said accessory shelf including a sheltered section thereof disposed within said enclosed interior region of said tower, said sheltered section of said accessory shelf extending continuously and substantially uninterrupted through said tower so as to establish the floor of a cavity within said enclosed interior region of said tower.

6. The housing assembly of claim 5, wherein said accessory shelf includes at least one accessory wing, said accessory wing extending laterally outwardly from said tower section.

7. The housing assembly of claim 1, wherein said tower section includes an apex connecting an uppermost end of said front-facing panel to an uppermost end of said rear-facing panel, said apex being disposed in a generally horizontal plane.

8. The housing assembly of claim 1 wherein said mounting bracket is directly connected to said front-facing panel, further including a base section disposed directly below said tower section, a drawer disposed within said base section for fore and aft movement along a reciprocating path generally parallel to said sagittal plane.

9. The housing assembly of claim 8, wherein said drawer has a drawer face extending generally perpendicularly to said sagittal plane, said drawer face including an auxiliary holder adapted to receive an auxiliary user interface in a reclining posture for fore and aft movement in concert with said drawer.

10. A housing assembly for the visual output device of a computer designed to be placed upon or integrated into a desk or other work surface, said assembly comprising:
a base section adapted to rise above the horizontal surface of a desk or other work surface,
a drawer disposed within and supported by said base section for fore and aft movement relative to said base section along a reciprocating path, said drawer having a drawer face being generally planar and having a rearward slant,
said drawer face including an auxiliary holder adapted to support an auxiliary user interface in an upright-reclining posture for fore and aft movement in concert with said drawer to optimize ergonomic positioning of the auxiliary user interface below a visual output device.

11. The housing assembly of claim 10, wherein said drawer face has a bottom edge, said auxiliary holder comprising a lip formed along said bottom edge.

12. The housing assembly of claim 11, wherein said lip has a generally hook-shaped configuration.

13. The housing assembly of claim 11, wherein said drawer face has a width, said lip extending across the entire width of said drawer face and being open at each end thereof.

14. The housing assembly of claim 10, wherein said rearward slant of said drawer face is between about 25-75 degrees relative to horizontal.

15. The housing assembly of claim 10, further including a tower section disposed directly above said base section and having left and right sides, a sagittal plane establishing a centerline generally bisecting said tower section into left and right portions, said tower section comprising a front-facing panel and a rear-facing panel, said front-facing and rear-facing panels each disposed generally perpendicularly to said sagittal plane and spaced apart from one another to form an enclosed interior region therebetween, a mounting bracket connected to said tower section, said mounting bracket adapted to support at least one visual output device of a computer, at least one concealed shelf disposed within said enclosed interior region of said tower and adapted to store a plurality of electrical components behind said front-facing panel, said concealed shelf forming the floor of a cavity within said enclosed interior region of said tower section, said cavity accessible from at least one side of said tower section and extending through said sagittal plane.

16. The housing assembly of claim 15, wherein said concealed shelf includes at least one elongated wire slot disposed in said enclosed interior region.

17. The housing assembly of claim 15, wherein said at least one concealed shelf includes a primary shelf comprising a generally horizontal support surface, said primary shelf including a sheltered section thereof extending continuously and substantially uninterrupted through said enclosed interior region of said tower, said primary shelf including a front ledge portion extending outwardly from said front-facing panel, said primary shelf including at least one primary wing extending laterally outwardly from said sheltered section.

18. The housing assembly of claim 17, wherein said at least one concealed shelf includes at least one accessory shelf supported by said tower and disposed above said primary shelf, said accessory shelf comprising a generally horizontal support surface disposed between said front-facing panel and said rear-facing panel, said accessory shelf including a sheltered section thereof disposed within said enclosed interior region of said tower, said sheltered section of said accessory shelf extending continuously and substantially uninterrupted through said tower between said left and right sides thereof, said accessory shelf including at least one elongated wire slot, said accessory shelf including at least one accessory wing extending laterally outwardly.

19. The housing assembly of claim 15, wherein said tower section includes an apex connecting an uppermost end of said front-facing panel to an uppermost end of said rear-facing panel, said apex being disposed in a generally horizontal plane.

20. A housing assembly for the visual output device of a computer designed to be placed upon a desk or other work surface, said assembly comprising:
a base section, said base section having left and right legs oriented generally parallel to one another, said left and right legs equally laterally spaced from one another on opposite sides of a sagittal plane, said sagittal plane establishing a centerline generally bisecting said assembly into left and right portions, each of said left and right legs having a bottom edge adapted to rest on the horizontal surface of a desk or other work surface, a drawer disposed between said left and right legs, said drawer operatively connected to said base section for fore and aft movement along a reciprocating path generally parallel to said sagittal plane, said drawer having a drawer face extending generally perpendicularly to said sagittal plane, said drawer face having a bottom edge, said drawer face includes an auxiliary holder adapted to receive an auxiliary user interface in a reclining posture for fore and aft movement in concert with said drawer, said drawer face being generally planar and having a rearward slant tilting away from said bottom edge, said auxiliary holder comprising a lip formed along said bottom edge, said lip having a generally hook-shaped configuration, said rearward slant of said drawer face being between 25-75 degrees relative to horizontal, said drawer face having a width, said lip extending across the entire width of said drawer face and being open at each end thereof,
a tower section coupled to said base section, said tower section comprising a front-facing panel disposed directly over said drawer, said tower section including a rear-facing panel, said front-facing and rear-facing panels each disposed generally perpendicularly to said sagittal plane and spaced apart from one another to form an enclosed interior region in-between, an apex connecting an uppermost end of said front-facing panel to an uppermost end of said rear-facing panel, said apex being disposed in a generally horizontal plane, said front-facing panel having a lowermost end terminating on top of said base section, at least one aperture disposed in said front-facing panel for routing an electronic cable through, said rear-facing panel having a lowermost end disposed behind said base section and terminating substantially congruent with said respective bottom edges of said left and right legs,
a mounting bracket disposed on said front-facing panel, said mounting bracket adapted to support at least one visual output device of a computer, said mounting bracket substantially centered along said sagittal plane, said aperture in said front-facing panel disposed laterally adjacent said mounting bracket,
a primary shelf comprising a generally horizontal support surface disposed between said base section and said tower section, said primary shelf including a sheltered section thereof extending continuously and substantially uninterrupted through said enclosed interior region of said tower, said sheltered section of said primary shelf extending continuously and substantially uninterrupted through said tower so as to establish a floor for a cavity within said enclosed interior region of said tower, said cavity accessible from both left and right sides of said tower section and extending substantially uninterrupted through said sagittal plane, at least one elongated wire slot disposed in said sheltered section, said primary shelf including a front ledge portion extending outwardly from said front-facing panel, said primary shelf including left and right primary wings extending laterally outwardly from respective sides of said sheltered section in cantilever fashion,
at least one accessory shelf supported by said tower and disposed between said primary shelf and said apex, said accessory shelf comprising a generally horizontal support surface disposed between said front-facing panel and said rear-facing panel, said accessory shelf including a sheltered section thereof disposed within said enclosed interior region of said tower, said sheltered section of said accessory shelf extending continuously and substantially uninterrupted through said tower so as to establish a floor for a cavity within said enclosed interior region of said tower, said accessory shelf including at least one elongated wire slot, said accessory shelf including left and right accessory wings, said left and right accessory wings extending laterally outwardly in cantilever fashion.
